(19) United States
(12) Patent Application Publication
(10) Pub. No.: US 2024/0326485 A1
(43) Pub. Date: Oct. 3, 2024

(54) PRINTING APPARATUS

(71) Applicant: SEIKO EPSON CORPORATION, Tokyo (JP)

(72) Inventor: Masahiro KAWAJIRI, SHIOJIRI-SHI (JP)

(21) Appl. No.: 18/617,408

(22) Filed: Mar. 26, 2024

(30) Foreign Application Priority Data
Mar. 29, 2023 (JP) 2023-052907

(51) Int. Cl. B41J 15/04; B41J 11/00; B41J 29/13

(52) U.S. Cl. CPC B41J 15/046; B41J 11/0095; B41J 29/13

(57) ABSTRACT

A printing apparatus includes a transport roller pair configured to transport a printing medium in a transport direction, an arm unit being configured to support the driven roller, a lower surface guide being configured to support the printing medium from below, an upper surface guide disposed at a position facing the lower surface guide and spaced apart from the lower surface guide, the upper surface guide being configured to form, between the upper surface guide and the lower surface guide, a transport path of the printing medium, and an upper surface guide pivoting shaft configured to pivotably support the upper surface guide, wherein an end portion of the upper surface guide located downstream in the transport direction is located below the arm unit, and the upper surface guide is configured to pivot in a direction away from the lower surface guide.

The present application is based on, and claims priority from JP Application Serial Number 2023-052907, filed Mar. 29, 2023, the disclosure of which is hereby incorporated by reference herein in its entirety.

### BACKGROUND

### 1. Technical Field

The present disclosure relates to a printing apparatus.

### 2. Related Art

In a related art, a printing apparatus including a transport roller pair that transports a printing medium to a printing unit that performs printing is known. In such a printing apparatus, an upper surface guide which covers the printing medium from above and a lower surface guide which supports the printing medium from below are provided at a transport path of the printing medium. The upper surface guide and the lower surface guide are disposed to face each other with a gap therebetween.

For example, JP-A-2018-69579 discloses a printing apparatus including an upper sheet guide which is an upper surface guide and a lower sheet guide which is a lower surface guide. The printing apparatus disclosed in JP-A-2018-69579 includes a main body and a cover which is pivotably attached to the main body via a pivoting shaft extending along a transport direction. The upper sheet guide is provided at the cover, and the lower sheet guide is provided at the main body. In the printing apparatus disclosed in JP-A-2018-69579, when a printing medium is jammed between the upper sheet guide and the lower sheet guide, the cover pivots to separate the upper sheet guide from the lower sheet guide, thereby eliminating the jam of the printing medium.

In the printing apparatus described above, there is a printing apparatus in which at least a portion of the upper surface guide is disposed between the transport roller pair. In such a printing apparatus, in a case where a structure in which the upper surface guide is separated from the lower surface guide is provided as in JP-A-2018-69579, the pivoting is hindered by one of the transport roller pair.

### SUMMARY

According to an aspect of the disclosure, there is provided a printing apparatus including a transport roller pair configured to transport a printing medium in a transport direction by sandwiching the printing medium between a transport roller and a driven roller, a printing unit configured to form an image by ejecting ink onto the printing medium transported by the transport roller pair, an arm unit provided upstream from the transport roller pair in the transport direction, the arm unit being configured to support the driven roller, a lower surface guide provided upstream from the transport roller pair in the transport direction, the lower surface guide being configured to support the printing medium from below, an upper surface guide disposed at a position facing the lower surface guide and spaced apart from the lower surface guide, the upper surface guide being configured to form, between the upper surface guide and the lower surface guide, a transport path of the printing medium, and an upper surface guide pivoting shaft configured to pivotably support the upper surface guide, wherein an end portion of the upper surface guide located downstream in the transport direction is located below the arm unit, and the upper surface guide is configured to pivot in a direction away from the lower surface guide.

### BRIEF DESCRIPTION OF THE DRAWINGS

FIG. 1 is a perspective view of a printing apparatus as viewed from a rear side.

FIG. 2 is a perspective view of the printing apparatus as viewed from the rear side.

FIG. 3 is a side view of a main portion illustrating each portion related to a transport path of the printing apparatus.

FIG. 4 is a perspective view of a vertical section taken along a plane S in FIG. 1.

FIG. 5 is a vertical sectional view taken along the plane S in FIG. 1.

FIG. 6 is a vertical sectional view taken along the plane S of FIG. 1.

### DESCRIPTION OF EMBODIMENTS

Exemplary embodiments of the present disclosure are described below with reference to the accompanying drawings. In the description, directions such as front, rear, left, right, up, and down are the same as the directions with respect to a printing apparatus 1 unless otherwise specified. In the drawings, a reference sign FR indicates a front side of the printing apparatus 1, a reference sign UP indicates an upper side of the printing apparatus 1, and a reference sign RH indicates a right side of the printing apparatus 1.

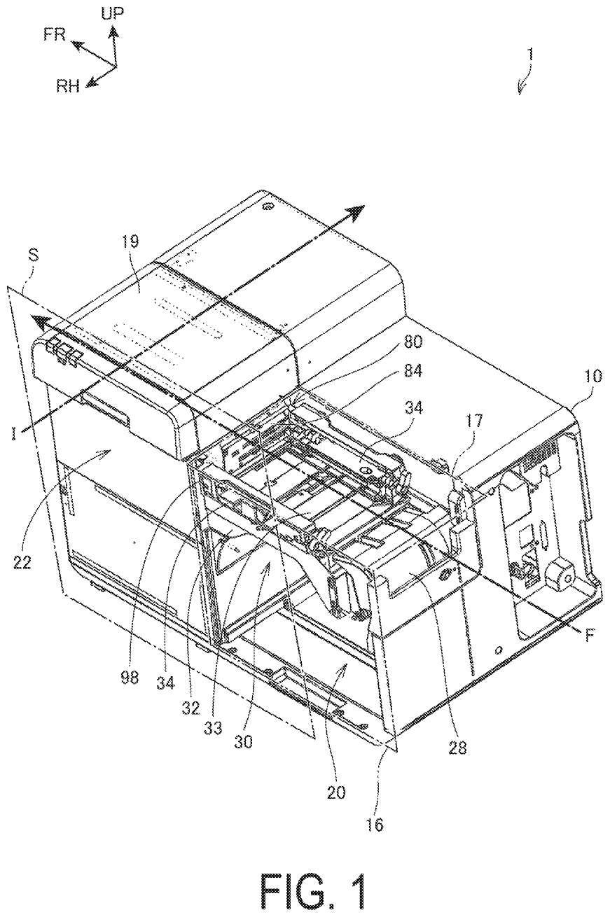

FIG. 1 is a perspective view of the printing apparatus 1 as viewed from the rear side. In FIG. 1, for convenience of description, an upper cover 17 is indicated by a two dot chain line. In FIG. 1, for convenience of description, a transport direction F and an intersecting direction I are indicated by a two dot chain line.

As will be described below, the printing apparatus 1 is a so-called line-type ink jet printer that includes a line-shaped ink jet head and prints characters and images on a printing medium by ejecting ink from the ink jet head.

The printing medium used for printing in the printing apparatus 1 is a cut sheet cut into a predetermined size or a continuous sheet. These sheets are formed of paper, synthetic resin, etc. These sheets may be, for example, fine paper that is suitable for ink jet printing and that has been subjected to a surface treatment for enhancing ink absorbency and fixability.

Examples of the continuous sheet include a roll sheet which is accommodated in the printing apparatus 1 in a state of being wound in a roll shape and a fanfold sheet which is supplied to the printing apparatus 1 from the outside of the printing apparatus 1 in a folded state. As the roll sheet, in addition to paper in which plain paper or fine paper is wound in a roll shape, label sheet in which labels of a standard size having an adhesive on the rear surface are arranged on release paper which is a mount and wound in a roll shape may be used.

In the present exemplary embodiment, a label sheet 100 is used as the printing medium. In the label sheet 100, a label of a predetermined size having an adhesive applied to a back surface thereof is disposed at a mount in which release paper releasable from the adhesive is formed in a long shape, and the label sheet 100 is wound in a roll shape. In the label sheet 100, a plurality of labels are disposed at equal intervals in the longitudinal direction of the mount. The printing apparatus 1 transports the label sheet 100 and prints characters and images on the printing surface of each label on the label sheet 100. That is, the printing apparatus 1 is a label printer. In this case, the label sheet 100 corresponds to a “printing medium”.

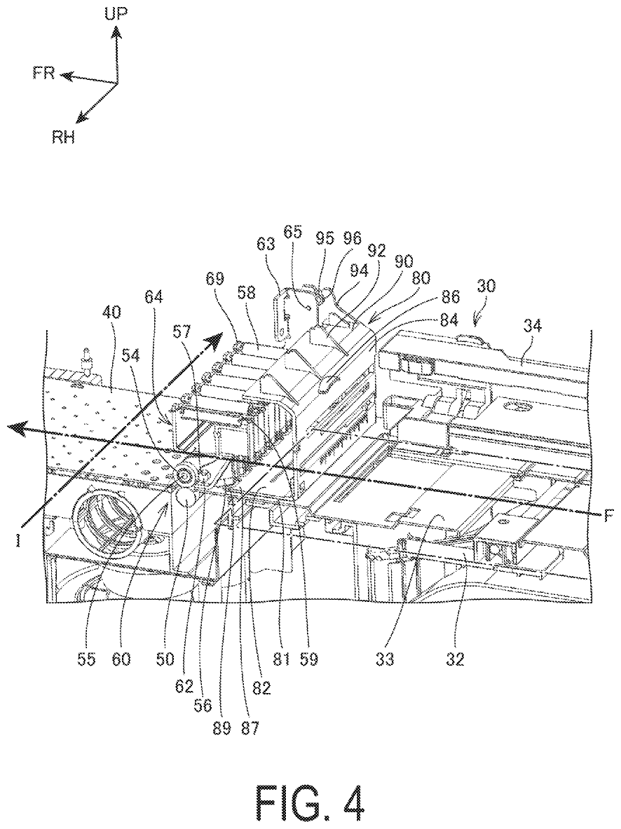

The label sheet 100 is illustrated in FIG. 4, which will be described below.

The printing apparatus 1 includes an apparatus case 10 which is a substantially rectangular parallelepiped housing. The apparatus case 10 is an exterior portion in which a side panel, a front panel, etc. are combined to form an outer shell of the printing apparatus 1.

On the right side surface of the apparatus case 10, a sheet cover 16 is provided in an openable and closable manner on the lower rear side. An accommodating unit 20 for accommodating the label sheet 100 is provided inside the sheet cover 16. In the printing apparatus 1, by opening the sheet cover 16, the label sheet 100 wound in a roll shape can be loaded into the accommodating unit 20.

In the apparatus case 10, an upper cover 17 is provided from above the sheet cover 16 to the upper surface of the apparatus case 10. The upper cover 17 pivots about a hinge provided substantially at the center of the upper surface of the apparatus case 10, and the upper cover 17 is formed openably and closably. In the printing apparatus 1, when the upper cover 17 is opened, it is possible to access the inside from the outside of the apparatus case 10, and it is possible to operate the accommodating unit 20 or each unit related to the transport.

The upper cover 17 corresponds to a “second opening and closing portion”.

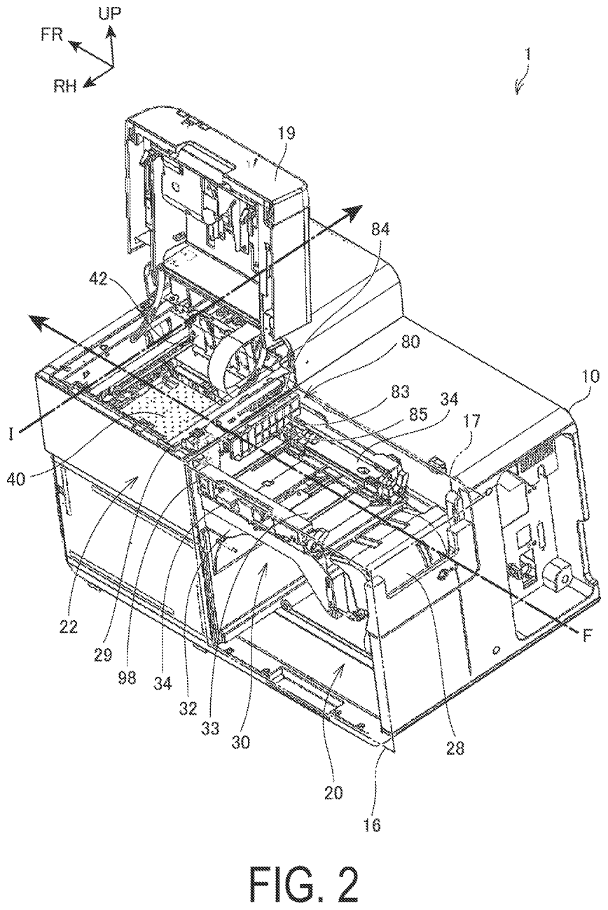

FIG. 2 is a perspective view of the printing apparatus 1 with a printing unit cover 19 opened, as viewed from the rear side. FIG. 2 illustrates a state in which the upper surface guide 80 pivots in a direction away from a lower guide member 32, and for convenience of description, illustrates a state in which a printing head 42 is retracted from above a platen 40.

In the apparatus case 10, the printing unit cover 19 is provided on the front side of the upper cover 17. The printing unit cover 19 pivots about a hinge provided substantially at the center of the upper surface of the apparatus case 10, and the printing unit cover 19 is formed openably and closably.

A printing unit 22 for printing on the label sheet 100 is provided below the printing unit cover 19. That is, the printing unit cover 19 covers the printing unit 22 from above. The printing unit cover 19 corresponds to a “first opening and closing portion”.

On the front surface of the apparatus case 10, a sheet discharge port 14 having a slit shape extending in the left-right direction is formed substantially at the center on the right side when viewed from the front surface. In the printing apparatus 1, the label sheet 100 after printing is discharged from the sheet discharge port 14.

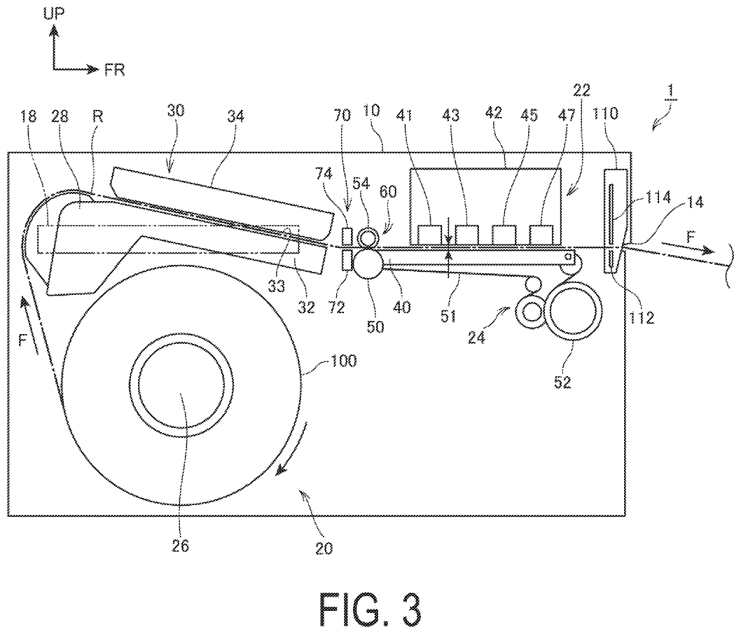

The sheet discharge port 14 is illustrated in FIG. 3 to be described below.

FIG. 3 is a side view of a main portion illustrating each portion related to a transport path R of the printing apparatus 1.

As illustrated in FIG. 3, the printing apparatus 1 includes an accommodating unit 20 for accommodating the label sheet 100, the printing unit 22 for performing printing on the label sheet 100, and a transport unit 24 for transporting the label sheet 100 from the accommodating unit 20 to the printing unit 22.

In the printing apparatus 1, the accommodating unit 20 is provided on the rear side, and the printing unit 22 is provided on the front side of the accommodating unit 20. The transport unit 24 is provided below the printing unit 22.

The accommodating unit 20 includes a roll shaft 26 to which the label sheet 100 is attached. The roll shaft 26 is a rod-shaped member provided rotatably in a circumferential direction. The label sheet 100 is accommodated in the accommodating unit 20 by inserting the roll shaft 26 through the center of the roll of the label sheet 100. For example, a drive device such as a motor may be coupled to the roll shaft 26, and the roll shaft 26 may rotate along with the driving of the drive device. In the printing apparatus 1, the label sheet 100 pivots by the pivoting of the roll shaft 26.

The transport path R through which one end of the label sheet 100 attached to the roll shaft 26 is pulled out and transported to the sheet discharge port 14 is formed in the printing apparatus 1.

A tension lever 28 is attached to the transport path R above the label sheet 100 accommodated in the accommodating unit 20. As illustrated in FIGS. 1 to 3, the tension lever 28 has a curved surface in the circumferential direction and is formed in a columnar shape extending in the left-right direction. The tension lever 28 applies tension to the label sheet 100 to prevent slack. One end of the label sheet 100 is pulled upward, comes into contact with the tension lever 28, is bent by the tension lever 28, and then extends forward.

As illustrated in FIGS. 1 to 3, a sheet guide unit 30 is provided in front of the tension lever 28. The sheet guide unit 30 guides the label sheet 100 forward, and suppresses skewing of the label sheet 100 and deviation of the transport of the label sheet 100.

The sheet guide unit 30 includes the lower guide member 32 that supports the label sheet 100 from below and a sheet pressing member 34 that is located on the upper surface side of the label sheet 100.

The lower guide member 32 includes a flat surface 33 extending in the front-rear direction. The flat surface 33 has a width dimension along the left-right direction that is longer than the width dimension of the label sheet 100. The label sheet 100 is placed at and supported by the flat surface 33 of the lower guide member 32.

The sheet pressing member 34 is located above the label sheet 100 facing the lower guide member 32, and prevents the label sheet 100 from floating. In the sheet guide unit 30, the label sheet 100 is transported in a state of being sandwiched between the lower guide member 32 and the sheet pressing member 34.

The lower guide member 32 corresponds to a “lower surface guide”.

The printing unit 22 for performing printing on the label sheet 100 is provided in front of the sheet guide unit 30. The printing unit 22 includes the platen 40 and the printing head 42. The printing head 42 of the present exemplary embodiment ejects inks of four colors of C (cyan), M (magenta), Y (yellow), and K (black) to form dots on the print surface of the label. The printing head 42 includes a nozzle unit 41 that ejects K (black) ink, a nozzle unit 43 that ejects C (cyan) ink, a nozzle unit 45 that ejects M (magenta) ink, and a nozzle unit 47 that ejects Y (yellow) ink. In the nozzle units 41 to 47, a plurality of nozzles for ejecting ink are arranged in a row in the width direction of the label sheet 100. The nozzles included in each of the nozzle units 41 to 47 are arranged along the intersecting direction I that intersects the transport direction F. In the present exemplary embodiment, the intersecting direction I is a direction orthogonal to the transport direction F. The intersecting direction I coincides with the width direction of the label sheet 100.

The printing head 42 is a line inkjet head that can eject ink without scanning in the width direction of the label sheet 100. Therefore, the nozzle rows of the nozzle units 41 to 47 are formed to have a width at least equal to or wider than the printable range of the label sheet 100. In the present exemplary embodiment, the printable range corresponds to the print surface of the label.

In the present exemplary embodiment, an arranged configuration example is given in the order of the nozzle units 41, 43, 45, and 47 along the transport direction F of the label sheet 100, but the arrangement order of the nozzles of each color in the transport direction F is arbitrary.

The platen 40 has a flat surface disposed along the transport direction F. The flat surface is located below the transport path R and faces the printing head 42. The nozzle units 41 to 47 and the platen 40 are disposed with an interval which is a so-called platen gap therebetween.

The platen 40 has a flat upper surface that supports the label sheet 100 from below. The platen 40 is provided at least over the entire printing range of the printing unit 22. The upper surface of the platen 40 is disposed substantially horizontally in the installation state and the use state of the printing apparatus 1.

As illustrated in FIG. 2, in the platen 40, a partition plate member 29 having a plate shape is provided at a rear end portion of both end portions arranged along the transport direction F. The partition plate member 29 is provided above the platen 40 to stand with respect to the upper surface, and is disposed so that the plane thereof is substantially orthogonal to the front-rear direction. The partition plate member 29 partitions the printing unit 22 from the accommodating unit 20 and the transport unit 24. When the printing unit cover 19 covers the printing unit 22, the lower end of the printing unit cover 19 abuts on the upper end of the partition plate member 29.

As illustrated in FIG. 2, when the printing unit cover 19 is opened, the platen 40 and the printing head 42 are exposed. That is, in the printing apparatus 1, when the printing unit cover 19 is opened, the inside of the apparatus case 10 can be accessed from the outside, and the platen 40, the printing head 42, etc. can be accessed. Therefore, in the printing apparatus 1, by opening the printing unit cover 19, for example, operation such as removal of a jam of the label sheet 100 generated between the platen 40 and the printing head 42 can be performed.

FIG. 4 is a perspective view of a vertical section taken on the plane S of FIG. 1. The plane S is a plane which is orthogonal to the intersecting direction I and intersects a transport roller 50. FIG. 4 illustrates a cross section viewed from the RH side.

As illustrated in FIGS. 3 and 4, the transport unit 24 includes the transport roller 50 having a cylindrical shape. The transport roller 50 is disposed such that the longitudinal direction thereof extends along the intersecting direction I, and is provided rotatably in the circumferential direction. The transport roller 50 is disposed between the front end of the sheet guide unit 30 and the rear end of the platen 40 in the transport direction F. As illustrated in FIG. 3, the transport roller 50 is disposed at a position in contact with the front end of the flat surface 33 of the lower guide member 32.

As illustrated in FIG. 3, a driven wheel is provided at one end of the transport roller 50. A transmission belt 51 is wound around the driven wheel. The transmission belt 51 is wound around a drive shaft included in a transport motor 52. Accordingly, the transport roller 50 and the transport motor 52 are coupled to each other via the transmission belt 51.

The transport motor 52 is a drive device that rotationally drives the transport roller 50. The transport motor 52 and the transmission belt 51 are provided below the platen 40.

The transport unit 24 includes a plurality of driven rollers 54. As illustrated in FIG. 4, the driven roller 54 has a columnar shape, and a circumferential surface thereof is formed of a flexible material such as a rubber material. The plurality of driven rollers 54 are rotatably disposed along the longitudinal direction of the transport roller 50. The driven rollers 54 are urged such that the circumferential surfaces thereof are in contact with the circumferential surface of the transport roller 50. Accordingly, the transport roller 50 and the driven roller 54 are disposed in contact with each other in a state in which the circumferential surfaces thereof face each other.

The transport roller 50 is disposed on the lower guide member 32 side, and the driven roller 54 is disposed on the sheet pressing member 34 side.

The transport roller 50 may be disposed on the lower guide member 32 side, in other words, on the platen 40 side. Further, for example, the transport unit 24 may include a transport belt movable on the upper surface of the platen 40 instead of the transport roller 50.

In the transport unit 24, when the transport motor 52 is driven, the transport roller 50 is driven to rotate via the transmission belt 51, and the driven roller 54 is driven to rotate. As a result, the label sheet 100 loaded between the lower guide member 32 and the sheet pressing member 34 is sandwiched between the transport roller 50 and the driven roller 54, and is transported to the printing unit 22 as the transport roller 50 is rotationally driven.

The label sheet 100 placed at the flat surface 33 and fed out from the sheet guide unit 30 is inserted and sandwiched between the transport roller 50 and the driven roller 54. When the transport roller 50 rotates in this state, the label sheet 100 is transported to the printing unit 22.

In the printing apparatus 1, a transport roller pair 60 is formed by the transport roller 50 and the driven roller 54.

As described above, the plurality of driven rollers 54 are in contact with the transport roller 50 along the longitudinal direction of the transport roller 50. As a result, even in the case of a printing medium having unevenness in the vertical direction, such as the label sheet 100 having a level difference between a label and a mount, the occurrence of a portion where the driven roller 54 and the printing medium are separated from each other in the intersecting direction I is suppressed.

The driven roller 54 includes a rotary shaft body 55. The rotary shaft body 55 is a rod-shaped member that extends in the longitudinal direction of the driven roller 54 through the center of the end surface of the driven roller 54.

Each of the driven rollers 54 is supported by an arm unit 56. One arm unit 56 supports one driven roller 54. That is, the printing apparatus 1 is provided with a plurality of the arm units 56. The arm units 56 are arranged along the longitudinal direction of the transport roller 50.

A front end portion of the arm unit 56 is divided into two portions, which are respectively coupled to end portions of the driven roller 54 located in the longitudinal direction of the rotary shaft body 55. Accordingly, the arm unit 56 pivotably supports the driven roller 54.

The arm unit 56 is a member that extends upward from the front end toward the rear end and is formed in a substantially J-shape in a side view. In each of the arm units 56, an insertion hole 57 which is a through hole penetrating along the intersecting direction I is provided at a position adjacent to the driven roller 54 supported by the front end portion in a side view.

An arm support shaft 62 having a columnar shape extending along the intersecting direction I is inserted into each of the insertion holes 57. The arm support shaft 62 has a length dimension in the longitudinal direction that is longer than the distance from the driven roller 54 provided at the left end to the driven roller 54 provided at the right end along the intersecting direction I.

The arm support shaft 62 couples each of the arm units 56 to each other.

The arm support shaft 62 is disposed substantially parallel to the longitudinal direction and the rotation axis of the rotary shaft body 55 in the longitudinal direction.

A coupling protrusion 59 protruding upward is provided at an upper end of the arm unit 56. One end of an urging member 58 is coupled to the coupling protrusion 59.

The urging member 58 is a so-called tension spring, and a longitudinal direction thereof extends along the transport direction F. An arm support shaft pressing member 64 is coupled to the other end of the urging member 58 via the coupling protrusion 69.

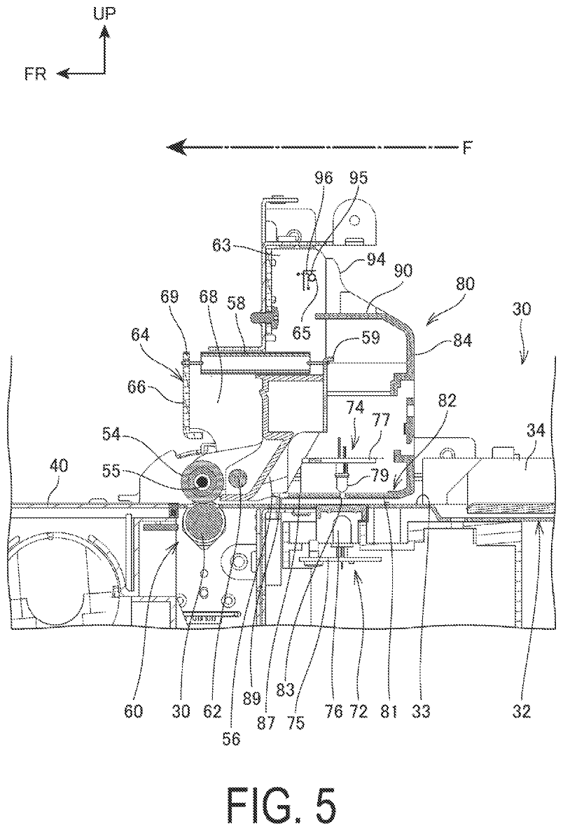

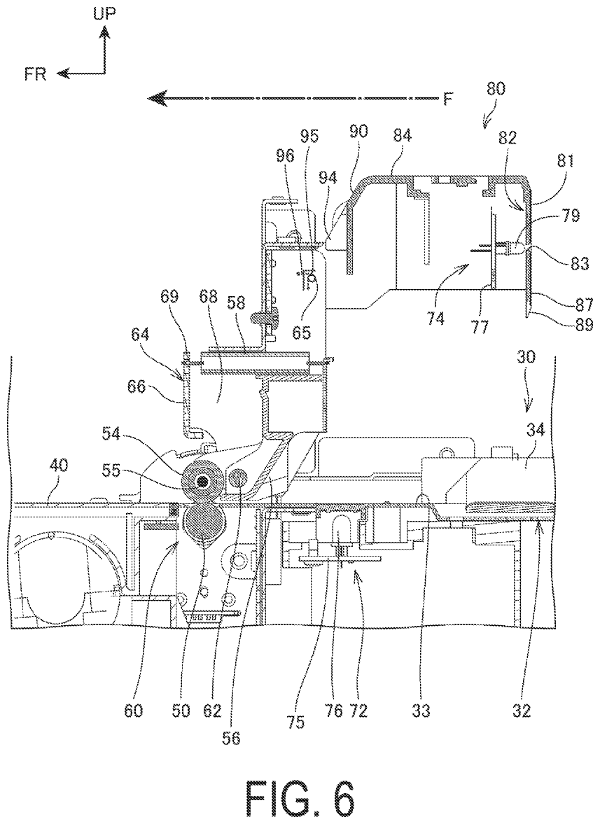

FIG. 5 is a vertical sectional view taken along a plane S of FIG. 1. FIG. 6 illustrates a cross section viewed from the RH side.

The arm support shaft pressing member 64 is a member formed by bending a plate-like member such as a sheet metal into a substantially U-shape protruding toward the downstream in the transport direction in plan view. The arm support shaft pressing member 64 is, for example, attached and fixed to a member that supports each mechanism of the printing apparatus 1. The arm support shaft pressing member 64 of the present exemplary embodiment is attached to, for example, the partition plate member 29.

The arm support shaft pressing member 64 includes a front surface portion 66 forming a plane orthogonal to the transport direction F, and a pair of side surface portions 68 orthogonal to the intersecting direction I. The front surface portion 66 is located above each of the driven rollers 54 and covers a portion of the arm unit 56 extending upward from the front side. One of the side surface portions 68 covers the driven roller 54 located at the left end and the arm unit 56 from the left, and the other side surface portion 68 covers the driven roller 54 located at the right end and the arm unit 56 from the right.

Each of the pair of side surface portions 68 is provided with a through hole penetrating along the intersecting direction I. A left end portion of the arm support shaft 62 is inserted into the through hole of one of the side surface portions 68, and a right end portion of the arm support shaft 62 is inserted into the through hole of the other side surface portion 68.

A plurality of the coupling protrusions 69 protruding upward are provided at the upper end of the front surface portion 66. The coupling protrusions 69 are provided at the upper end of the arm support shaft pressing member 64 in the same number as the coupling protrusions 59. As described above, the other end of the urging member 58 is coupled to each of the coupling protrusions 69.

As described above, the arm support shaft pressing member 64 is fixed to the partition plate member 29. In this state, each of the arm units 56 is urged so as to approach the arm support shaft pressing member 64 along the transport direction F by the restoring force of the urging member 58.

As illustrated in FIGS. 4 and 5, a protruding piece 63 protruding upward is provided at the left end of the arm support shaft pressing member 64. The protruding piece 63 extends upward beyond the urging member 58. The protruding piece 63 is provided with a pivoting shaft hole 65 which is a through hole penetrating along the intersecting direction I.

As illustrated in FIG. 4, an upper surface guide 80 is provided above the front end portion of the lower guide member 32. The upper surface guide 80 is formed of, for example, a resin material, and is a plate-like member formed in a substantially C-shape when viewed from the intersecting direction I. The upper surface guide 80 is disposed in front of the sheet pressing member 34, and covers each of the arm units 56 from the upstream in the transport direction F. As illustrated in FIG. 1, the upper surface guide 80 is covered by the printing unit cover 19 from above, and is covered by the upper cover 17 from behind.

The upper surface guide 80 is a member that guides the label sheet 100 from above on the downstream of the sheet pressing member 34 in the transport path R.

As illustrated in FIG. 5, the upper surface guide 80 includes an opposed surface portion 82 forming an opposed surface 81 opposed to the flat surface 33 of the lower guide member 32. The opposed surface portion 82 is a flat plate portion extending substantially parallel to the flat surface 33. The opposed surface portion 82 is provided with a slit hole 83 which is a through hole penetrating in the plate thickness direction of the opposed surface portion 82. The slit hole 83 has a slit shape extending along the intersecting direction I in plan view.

As illustrated in FIG. 2, a plurality of convex portions 85 are provided at the opposed surface 81. The convex portion 85 is formed in a linear shape extending along the transport direction F in plan view, and protrudes from the opposed surface further than other portions of the opposed surface 81. A plurality of the convex portions 85 are arranged along the intersecting direction I.

In the printing apparatus 1, the printing medium is transported below the opposed surface 81. By providing these convex portions 85, when the printing medium to be transported and the opposed surface 81 come into contact with each other, the convex portions 85 mainly come into contact with each other. As a result, the contact area and the contact frequency between the printing medium and the opposed surface 81 are reduced, and for example, the occurrence of contact marks, etc. on the printing medium such as glossy paper is suppressed.

As illustrated in FIG. 4, in the opposed surface portion 82, a front edge portion 87 which is an edge portion located on the downstream in the transport direction F extends from the rear of each of the arm units 56 to a position adjacent to the arm unit 56. The front edge portion 87 is provided with a plurality of extending portions 89. The extending portion 89 has a width dimension that allows the extending portion 89 to be disposed in a gap between the adjacent arm units 56 in the intersecting direction I, and extends between the adjacent arm units 56. That is, each of the extending portions 89 extends to a position overlapping the arm unit 56 when viewed from the intersecting direction I. A lower surface of each of the extending portions 89 is disposed at substantially the same plane as the opposed surface 81.

As a result, the upper surface guide 80 can guide the label sheet 100 to a position overlapping the arm unit 56. As a result, the upper surface guide 80 can guide the label sheet 100 in a wider range in the transport path R, and can suppress the jam and sticking of the label sheet 100.

The upper surface guide 80 includes a standing surface portion 84. The standing surface portion 84 has a flat plate shape standing and extending from an edge portion located on the upstream in the transport direction F in the opposed surface portion 82. The standing surface portion 84 stands from the opposed surface portion 82 and extends above the urging member 58.

An operation piece 86 is provided at an upper end portion of the standing surface portion 84. The operation piece 86 protrudes from the standing surface portion 84 toward the upstream in the transport direction F, and has a knob shape on which the user can hook a finger or a nail.

The upper surface guide 80 includes a regulating surface portion 90. The regulating surface portion 90 has a flat plate shape which stands and extends toward the downstream in the transport direction F from an edge portion located at the upper end of the standing surface portion 84. The regulating surface portion 90 stands from the standing surface portion 84 and extends to above one end of the urging member 58.

A plurality of ribs 92 are provided at the upper surface of the regulating surface portion 90. Each of the ribs 92 extends upright from the regulating surface portion 90 to a position close to the printing unit cover 19.

A pivoting piece 94 is provided at a left end portion of the regulating surface portion 90 in the left-right direction. The pivoting piece 94 has a flat plate shape having a plane orthogonal to the intersecting direction I. The pivoting piece 94 stands from the regulating surface portion 90 and extends upward to a position overlapping the protruding piece 63 when viewed from the intersecting direction I.

In the intersecting direction I, the pivoting piece 94 is located on the left side of the protruding piece 63. A shaft portion 95 having a protruding shape that protrudes to the right is provided at the pivoting piece 94, and the shaft portion 95 is inserted into the pivoting shaft hole 65.

As illustrated in FIG. 5, the pivoting piece 94 is provided with an urging member 96. The urging member 96 is, for example, a torsion coil spring. One end of the urging member 96 is coupled to the pivoting piece 94, and the other end of the urging member 96 is coupled to the protruding piece 63. In this manner, the upper surface guide 80 is coupled to the arm support shaft pressing member 64 via the urging member 96. As illustrated in FIGS. 4 and 5, the upper surface guide 80 is urged by an elastic force of the urging member 96 with the shaft portion 95 as a fulcrum such that the opposed surface 81 is disposed at a position facing the flat surface 33. When the upper surface guide 80 is disposed in this manner, the opposed surface 81 and the flat surface 33 are disposed with a gap therebetween to the extent that the label sheet 100 can pass through and the deflection of the label sheet 100 can be suppressed.

A pivoting piece having substantially the same shape as the pivoting piece 94 is provided at a right end portion of the regulating surface portion 90 in the left-right direction. The pivoting piece includes a through hole penetrating in a plate thickness direction.

As illustrated in FIGS. 1 and 2, a pivoting support member 98 is provided on the right side of the upper surface guide 80 on the upper surface side of the lower guide member 32. The pivoting support member 98 includes a protruding shaft body that protrudes toward the upper surface guide 80. The shaft body and the shaft portion 95 extend along substantially the same straight line. The shaft body is inserted into the through hole of the pivoting piece provided at the right end portion of the regulating surface portion 90.

Thus, the upper surface guide 80 is pivotably supported by the arm support shaft pressing member 64 and the pivoting support member 98 with the shaft body and the shaft portion 95 as a rotation axis.

The pivoting support member 98 may be provided with an urging member such as a torsion coil spring.

The shaft body and the shaft portion 95 correspond to an “upper surface guide pivoting shaft”.

FIG. 6 is a vertical sectional view taken along the plane S of FIG. 1. FIG. 6 illustrates a cross section viewed from the RH side. FIG. 6 illustrates a state where the upper surface guide 80 pivots in a direction away from the lower guide member 32.

In the printing apparatus 1, in a state where the printing unit cover 19 is closed, the plurality of ribs 92 come into contact with the lower end of the printing unit cover 19, and thus the pivoting of the upper surface guide 80 is regulated. In the printing apparatus 1, when the printing unit cover 19 is opened, the upper surface guide 80 can pivot.

As illustrated in FIG. 6, the upper surface guide 80 is pivotable about the shaft body and the shaft portion 95 as a rotation axis. When the upper surface guide 80 pivots, the opposed surface portion 82 is separated upward from the lower guide member 32.

When the upper surface guide 80 pivots by a predetermined amount, the plurality of ribs 92 come into contact with the partition plate member 29, so that the pivoting of the upper surface guide 80 is regulated. In such a regulated state, the opposed surface 81 is disposed as a flat surface which faces the upstream in the transport direction F and is orthogonal to the transport direction F.

As illustrated in FIG. 3, the printing apparatus 1 is provided with a label detector 70 on the transport path R. The label detector 70 detects the front end and the rear end of the label sheet 100 and the front end and the rear end of the label. The label detector 70 of the present exemplary embodiment is disposed on the downstream of the sheet guide unit 30 and on the upstream of the transport roller 50. The label detector 70 is, for example, an optical transmission-type sensor that includes a light emitting unit 72 on the lower surface side of the label sheet 100 and a light receiving unit 74 on the upper surface side of the label sheet 100 in the transport path R. The light emitting unit 72 and the light receiving unit 74 are disposed facing each other along the vertical direction with a gap therebetween that allows the label sheet 100 to pass through. That is, the light emitting unit 72 and the light receiving unit 74 are disposed to face each other along the thickness direction of the label sheet 100. Thus, the light emitting unit 72 and the light receiving unit 74 are disposed at substantially the same position in the front-rear direction.

Note that the label detector 70 may be disposed downstream of the transport roller 50 and upstream of the printing head 42.

Further, for example, the light emitting unit 72 may be disposed on the lower guide member 32 side, and the light receiving unit 74 may be disposed on the sheet pressing member 34 side. In this case, the light emitting unit 72 may be disposed on the platen 40 side, and the light receiving unit 74 may be disposed on the printing head 42 side.

The label detector 70 corresponds to a “detection unit”.

As illustrated in FIG. 5, the light emitting unit 72 includes a light emitting element 76. For example, a light-emitting diode (LED) is used as the light emitting element 76.

The light emitting unit 72 is not limited to the LED, and may include another light emitting element such as a semiconductor laser.

The light receiving unit 74 includes a light receiving element 79. As the light receiving element 79, for example, a phototransistor, a photo IC, or a photodiode is used. When the light receiving element 79 receives light having a signal intensity of a predetermined value or more, the light receiving element 79 outputs a detection voltage as an output value indicating the amount of received light according to the amount of received light. The signal intensity of the light received by the light receiving element 79 is, for example, illuminance.

In the label detector 70, the light emitting unit 72 and the light receiving unit 74 can be disposed at positions where the light receiving unit 74 can receive the light emitted from the light emitting unit 72 at a predetermined signal intensity. In this case, the output value indicating the amount of light received by the light receiving element 79 varies depending on whether the label sheet 100 is not present directly below the light receiving element 79, whether a mount is present, or whether a label is present. That is, the signal intensities of the light emitted from the light emitting element 76, the light transmitted through the mount, and the light transmitted through the label are different from each other. Therefore, the label detector 70 can detect the front end and the rear end of the label sheet 100 and the front end and the rear end of the label based on the output value indicating the amount of light received by the light receiving element 79.

As illustrated in FIG. 5, the light emitting element 76 is held by the light emitting unit holding portion 75. The light emitting unit holding portion 75 is attached to the front end portion of the lower guide member 32 so as to be movable along the intersecting direction I. A slit-shaped through hole penetrating in the plate thickness direction is provided in a front end portion of the lower guide member 32. The light emitted from the light emitting element 76 is emitted upward through the through hole.

As illustrated in FIG. 5, the light receiving element 79 is held by a light receiving unit holding portion 77. The light receiving unit holding portion 77 is formed in a cylindrical shape, and covers the entire circumferential direction of the light receiving element 79 in a state where the emission direction of the light receiving element 79 is opened. The light receiving unit holding portion 77 is attached to the upper surface guide 80 so as to be movable along the intersecting direction I. Thus, the light receiving unit 74 is attached to the upper surface guide 80. The light receiving unit 74 is formed pivotably together with the upper surface guide 80.

In this manner, in the printing apparatus 1, since the light receiving unit 74 is provided at the upper surface guide 80, it is possible to accommodate other mechanisms and members around the upper surface guide 80. Therefore, in the printing apparatus 1, it is possible to improve the degree of freedom in design.

The light receiving element 79 attached to the upper surface guide 80 is disposed to face the slit hole 83. The light receiving element 79 can receive the light emitted from the light emitting element 76 through the slit hole 83.

As illustrated in FIG. 3, a cutter unit 110 is disposed on the downstream of the printing head 42 in the transport direction F, in other words, on the front side of the printing head 42. The cutter unit 110 includes a fixed blade 112 and a movable blade 114 disposed with the transport path R interposed therebetween, and the movable blade 114 is coupled to a drive device such as a motor for driving the cutter via a gear, etc. In the cutter unit 110, when the motor is driven, the movable blade 114 moves toward the fixed blade 112 and cuts the label sheet 100. The cutter unit 110 may cut the label sheet 100 so as to leave a portion of the label sheet 100 uncut in the width direction, or may completely cut the label sheet 100. The printing apparatus 1 cuts the label sheet 100 printed by the printing head 42 to a specific length with the cutter unit 110, and discharges the cut label sheet 100 from the sheet discharge port 14.

The cutter unit 110 may be formed separately from the printing apparatus 1, and may be detachably provided at the front surface of the printing apparatus 1, for example.

As illustrated in FIG. 3, the printing apparatus 1 includes a control board 18 that controls each unit of the printing apparatus 1. The control board 18 includes a CPU as an arithmetic execution unit, a ROM, a RAM, etc. In the ROM of the control board 18, firmware executable by the CPU, data related to the firmware, etc. are accommodated in a nonvolatile manner. The RAM temporarily stores data, etc. related to firmware executed by the CPU. The control board 18 may include other peripheral circuits, etc. The control board 18 may include a storing unit capable of storing various programs and data such as a control program and data related to the control program in a nonvolatile manner.

The control board 18 is configured to detect the operation performed on the printing apparatus 1 and the transport amount of the label sheet 100.

The control board 18 is formed so as to be capable of controlling a drive device included in the printing apparatus 1, such as the transport motor 52.

In the printing head 42, the control board 18 supplies a voltage to a pump that supplies ink from the ink tank and piezoelectric elements provided in the nozzle units 41 to 47 of the printing head 42 to operate the pump and the piezoelectric elements. Thus, in the printing apparatus 1, ink droplets are ejected from the nozzles of the nozzle sections 41 to 47 to form dots.

The control board 18 is configured to cause the light emitting element 76 to emit light and to acquire a detection value of the label detector 70. The label detector 70 functions as a detection means in cooperation with the control board 18.

Next, the operation of the present exemplary embodiment will be described.

In the printing apparatus 1, the label sheet 100 accommodated in the accommodating unit 20 is transported to the printing unit 22 by the transport unit 24, and printing is performed on each of the printing surfaces of the labels on the label sheet 100.

In the printing apparatus 1, the label sheet 100 may be jammed or stuck between the upper surface guide 80 and the lower guide member 32. In this case, the user first opens the upper cover 17 and the printing unit cover 19. Thus, the user can access the upper surface guide 80.

Next, the user holds the operation piece 86 and rotates the upper surface guide 80. Accordingly, the opposed surface portion 82 is separated from the lower guide member 32, and the opposed surface 81 faces the upstream in the transport direction F. As a result, for example, the user can easily peel the label stuck to the opposed surface 81 from the opposed surface 81. That is, in the printing apparatus 1, by rotating the upper surface guide 80, it is possible to easily eliminate the jam or sticking of the label sheet 100 which occurs between the upper surface guide 80 and the lower guide member 32.

When the label sheet 100 is no longer jammed or stuck between the upper surface guide 80 and the lower guide member 32, the user releases the operation piece 86 held by the user. As a result, the upper surface guide 80 pivots by the restoring force of the urging member 96, and the upper surface guide 80 is disposed again at a position where the opposed surface 81 faces the flat surface 33, that is, a position where the label sheet 100 can be guided. In this manner, the upper surface guide 80 can easily return from a position separated from the lower guide member 32 to a position capable of guiding the label sheet 100 by being urged by the urging member 96. For this reason, in the printing apparatus 1, printing on the label sheet 100 in a state where the upper surface guide 80 is deviated from a position at which the label sheet 100 can be guided is suppressed.

Each of the above-described exemplary embodiments merely illustrates a specific example to which the present disclosure is applied. The present disclosure is not limited to the configuration of the above-described embodiment, and can be implemented in various aspects without departing from the gist of the disclosure.

In the above-described exemplary embodiment, the upper surface guide 80 is provided with the light receiving unit 74. However, the present disclosure is not limited thereto, and the upper surface guide 80 may be provided with an end member or a mechanism such as a radio frequency identification (RFID) antenna.

In the above-described exemplary embodiment, the pivoting of the upper surface guide 80 is regulated by the printing unit cover 19 in a state where the printing unit cover 19 is closed. However, the present disclosure is not limited thereto, and the upper surface guide 80 may be provided pivotably in a state where the printing unit cover 19 is closed, for example, by omitting the rib 92.

In the above-described exemplary embodiment, the upper surface guide 80 is urged by the elastic force of the urging member 96, which is a torsion coil spring, such that the opposed surface 81 is disposed at a position facing the flat surface 33. However, the urging member 96 is not limited thereto, and may be another member having an elastic force. Further, for example, the upper surface guide 80 may be urged by a magnetic force of a magnetic body such as a magnet so that the opposed surface 81 is disposed at a position facing the flat surface 33.

In the above-described exemplary embodiment, other devices such as a peeler that performs a process of peeling a label from a mount and the cutter unit 110 may be provided at the front surface of the printing apparatus 1.

In the above-described exemplary embodiment, the label printer is exemplified as the printing apparatus 1. However, the printing apparatus 1 is not limited to the label printer. The printing apparatus 1 is an apparatus including a transport apparatus that transports a printing medium and the printing unit 22 that performs printing on the printing medium. For example, the printing apparatus 1 may be a large format printer, a textile printing machine that performs textile printing, etc.

In the exemplary embodiment described above, a line head type head is exemplified as the printing head 42, but the disclosure is not limited thereto, and a serial head type head may be used. Further, the printing method of the printing head 42 is not limited to the ink jet method.

Directions such as horizontal and vertical directions and various shapes in the above-described exemplary embodiments include a so-called equivalent range in which the same effects as those of the directions and the shapes are achieved unless otherwise specified.

Summary of Present Disclosure A summary of the present disclosure will be appended below.

### APPENDIX 1

According to an aspect of the disclosure, there is provided a printing apparatus including a transport roller pair configured to transport a printing medium in a transport direction by sandwiching the printing medium between a transport roller and a driven roller, a printing unit configured to form an image by ejecting ink onto the printing medium transported by the transport roller pair, an arm unit provided upstream from the transport roller pair in the transport direction, the arm unit being configured to support the driven roller, a lower surface guide provided upstream from the transport roller pair in the transport direction, the lower surface guide being configured to support the printing medium from below, an upper surface guide disposed at a position facing the lower surface guide and spaced apart from the lower surface guide, the upper surface guide being configured to form, between the upper surface guide and the lower surface guide, a transport path of the printing medium, and an upper surface guide pivoting shaft configured to pivotably support the upper surface guide, wherein an end portion of the upper surface guide located downstream in the transport direction is located below the arm unit, and the upper surface guide is configured to pivot in a direction away from the lower surface guide.

As a result, in the printing apparatus, by rotating the upper surface guide, it is possible to easily eliminate the jam or sticking of the label sheet which occurs between the upper surface guide and the lower guide member.

### APPENDIX 2

The printing apparatus according to Appendix 1, including an urging member configured to urge the upper surface guide to a position where the upper surface guide faces the lower surface guide.

Accordingly, in the printing apparatus, printing on the printing medium is suppressed in a state where the upper surface guide is deviated from the position at which the printing medium can be guided.

### APPENDIX 3

The printing apparatus according to Appendix 1 or Appendix 2, including an exterior portion configured to accommodate the transport roller pair, the printing unit, the arm unit, the lower surface guide, the upper surface guide, and the upper surface guide pivoting shaft inside the exterior portion, wherein a first opening and closing portion is provided at the exterior portion, the first opening and closing portion being configured to open and close a portion of the exterior portion, and the upper surface guide pivoting shaft is covered by the first opening and closing portion.

Accordingly, in the printing apparatus, the pivoting of the upper surface guide can be regulated by the opening and closing of the first opening and closing portion.

### APPENDIX 4

The printing apparatus according to Appendix 3, wherein a second opening and closing portion is provided at the exterior portion at a position different from a position at which the first opening and closing portion is provided, the second opening and closing portion being configured to open and close a portion of the exterior portion, the second opening and closing portion is configured to cover at least a portion of the upper surface guide in a closed state, and the upper surface guide is accessible from outside the exterior portion in a state where the second opening and closing portion is opened.

Thus, the upper surface guide is protected from the outside of the apparatus by the second opening and closing portion.

### APPENDIX 5

The printing apparatus according to Appendices 1 to 4, wherein a detection unit is provided at the upper surface guide, the detection unit being configured to detect the printing medium, and the detection unit is provided pivotably together with the upper surface guide.

Accordingly, in the printing apparatus, it is possible to improve the degree of freedom in design.

### APPENDIX 6

The printing apparatus according to Appendices 1 to 5, wherein a plurality of the arm units are provided side by side along a longitudinal direction of the transport roller.

Accordingly, even in the case of the printing medium having unevenness in the vertical direction, the occurrence of a portion where the driven roller and the printing medium are separated from each other in the intersecting direction is suppressed.

### APPENDIX 7

The printing apparatus according to Appendix 6, wherein at least a portion of an end portion of the upper surface guide located downstream in the transport direction is disposed between the plurality of arm units.

With this configuration, the upper surface guide can guide the printing medium in a wider range in the transport path, and can suppress the jam or sticking of the printing medium.

What is claimed is:

1. A printing apparatus comprising:
a transport roller pair configured to transport a printing medium in a transport direction by sandwiching the printing medium between a transport roller and a driven roller;
a printing unit configured to form an image by ejecting ink onto the printing medium transported by the transport roller pair;
an arm unit provided upstream from the transport roller pair in the transport direction, the arm unit being configured to support the driven roller;
a lower surface guide provided upstream from the transport roller pair in the transport direction, the lower surface guide being configured to support the printing medium from below;
an upper surface guide disposed at a position facing the lower surface guide and spaced apart from the lower surface guide, the upper surface guide being configured to form, between the upper surface guide and the lower surface guide, a transport path of the printing medium; and
an upper surface guide pivoting shaft configured to pivotably support the upper surface guide, wherein
an end portion of the upper surface guide located downstream in the transport direction is located below the arm unit, and
the upper surface guide is configured to pivot in a direction away from the lower surface guide.

2. The printing apparatus according to claim 1, comprising an urging member configured to urge the upper surface guide to a position where the upper surface guide faces the lower surface guide.

3. The printing apparatus according to claim 1, comprising an exterior portion configured to accommodate the transport roller pair, the printing unit, the arm unit, the lower surface guide, the upper surface guide, and the upper surface guide pivoting shaft inside the exterior portion, wherein
a first opening and closing portion is provided at the exterior portion, the first opening and closing portion being configured to open and close a portion of the exterior portion, and
the upper surface guide pivoting shaft is covered by the first opening and closing portion.

4. The printing apparatus according to claim 3, wherein
a second opening and closing portion is provided at the exterior portion at a position different from a position at which the first opening and closing portion is provided, the second opening and closing portion being configured to open and close a portion of the exterior portion,
the second opening and closing portion is configured to cover at least a portion of the upper surface guide in a closed state, and
the upper surface guide is accessible from outside the exterior portion in a state where the second opening and closing portion is opened.

5. The printing apparatus according to claim 1, wherein
a detection unit is provided at the upper surface guide, the detection unit being configured to detect the printing medium, and
the detection unit is provided pivotably together with the upper surface guide.

6. The printing apparatus according to claim 1, wherein
a plurality of the arm units are provided side by side along a longitudinal direction of the transport roller.

7. The printing apparatus according to claim 6, wherein
at least a portion of an end portion of the upper surface guide located downstream in the transport direction is disposed between the plurality of arm units.
